(19) United States
(12) Patent Application Publication
(10) Pub. No.: US 2021/0095074 A1
(43) Pub. Date: Apr. 1, 2021

(54) POLYOXAZOLIN WITH A PHOTOACTIVATABLE GROUP

(71) Applicant: BASF SE, Ludwigshafen am Rhein (DE)

(72) Inventors: Rupert KONRADI, Ludwigshafen (DE); Sarah-Jane SCHAUKSDAT, Ludwigshafen (DE); Peter OHLEMUELLER, Bensheim (DE)

(73) Assignee: BASF SE, Ludwigshafen am Rhein (DE)

(21) Appl. No.: 16/628,203

(22) PCT Filed: Jun. 28, 2018
(86) PCT No.: PCT/EP2018/067424

§ 371 Date: Jan. 2, 2020

(30) Foreign Application Priority Data
Jul. 7, 2017 (EP) 17180200.2

(51) Int. Cl. C08G 73/02; C09D 5/16; C09D 179/02

(52) U.S. Cl. CPC C08G 73/0233; C09D 179/02; C09D 5/1637

(57) ABSTRACT

Polyoxazolin with a photoactivatable group The present invention relates to a polyoxazoline of the formula I as defined below; to a method for synthesizing the polyoxazoline of the formula I, comprising the reaction of an aryl ketone which comprises a deprotonated phenolic hydroxy group with an intermediate polyoxazoline of the formula X as defined below; to a polymer comprising the polyoxazoline of the formula I, where E comprises an ethylenically unsaturated group in polymerized form; to a coated material comprising a coating which contains the polyoxazoline of the formula I or the polymer; and to a use of the polyoxazoline of the formula I or the polymer as antifouling coating.

The present invention relates to a polyoxazoline of the formula I as defined below; to a method for synthesizing the polyoxazoline of the formula I, comprising the reaction of an aryl ketone which comprises a deprotonated phenolic hydroxy group with an intermediate polyoxazoline of the formula X as defined below; to a polymer comprising the polyoxazoline of the formula I, where E comprises an ethylenically unsaturated group in polymerized form; to a coated material comprising a coating which contains the polyoxazoline of the formula I or the polymer; and to a use of the polyoxazoline of the formula I or the polymer as antifouling coating. The present invention comprises combinations of preferred features with other preferred features.

A goal was to find a water-soluble prepolymer or macromonomer that can be used to fabricate a prepolymer with photoactivatable units that allow for a simple UV curing under ambient conditions leading to simultaneous surface bonding and cohesive hydrogel formation.

Polyoxazolines with photodimerizable groups are known, for example Korchia et al. ‘Photodimerization as an alternative to photocrosslinking of nanoparticles: proof of concept with amphiphilic linear polyoxazoline bearing coumarin unit’ in Polym. Chem., 2015, Vol. 6, pages 6029-6039; or Kempe et al. ‘Three-Fold Metal-Free Efficient (“Click”) Reactions onto a Multifunctional Poly(2-oxazoline) Designer Scaffold’ in Macromolecules 2011, Vol. 44, pages 6424-6432. Drawback of these methods is that cross-linking only works through specific reaction between two complementary reactive groups such as two coumarin units. No simultaneous surface bonding, not generally applicable.

Polyoxazolines with benzophenone groups in a side chain are described by Samuel et al. ‘Tailormade Microfluidic Devices Through Photochemical Surface Modification’ in Macromol. Chem. Phys. 2010, Vol. 211, pages 195-203. Drawback of these compounds is that for the fabrication, two polymer-analogous reactions are needed, involving partial hydrolysis under harsh conditions that limits reaction to polyoxazolines carrying no sensitive functional groups and reaction with a functional benzophenone. In addition the polymers are not well defined, in particular not the number of photoactivatable units per polymer chain and therefore the cross-linking density.

Object was to overcome the drawback of these methods.

The object was solved by a polyoxazoline of the formula I

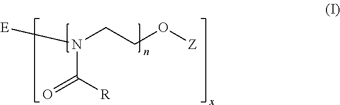

where
E is an electrophile residue,
R is C₁-C₁₂ alkyl, C₂-C₁₂ alkenyl, or phenyl,
Z is an aryl ketone residue,
n is from 2 to 200, and
x is 1, 2, 3, 4, 5 or 6.

The index n is preferably 3 to 100, more preferably 5 to 50, and in particular 10 to 20.

The index x is preferably 1, 2, 3, or 4. In one preferred form x is 1. In another preferred form x is 2, 3 or 4.

Z is an aryl ketone residue, such as an aryl ketone residue derived from benzophenone, acetophenone, phenyl glyoxyl, anthraquinone, anthrone, and anthrone derivatives.

Z is preferably an aryl ketone residue derived from benzophenone or acetophenone.

In particular, Z is a benzophenone residue of the formula II

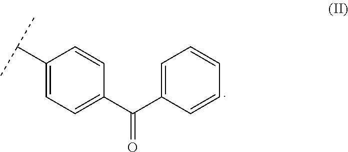

E is an electrophile residue, such as alkyl, alkenyl, (meth)acryloyl, benzyl, or a substituted benzyl.

Preferably E is C₁₋₁₈ alkyl, C₂₋₁₈ alkenyl, (meth)acryloyl, benzyl, or a substituted benzyl selected from the electrophile residues of the formula III, IV, V, VI, VII, VIII or IX.

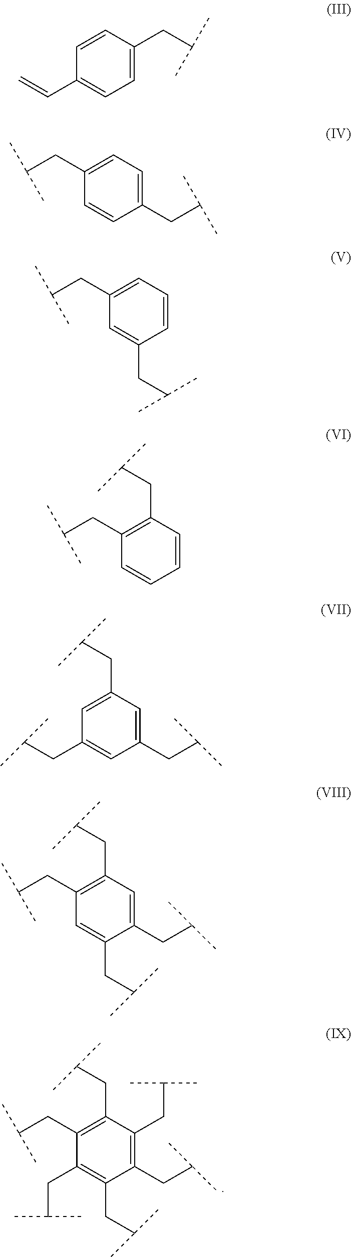

In particular E is an electrophile residue of the formula III, IV, V, VI, VII, VIII or IX.

The index x usually depends from the free valencies of the electrophile. For example, in case E is an electrophil selected from C₁₋₁₈ alkyl, C₂₋₁₈ alkenyl, (meth)acryloyl, benzyl, or a substituted benzyl selected from formula (III) then x is 1. For example, in case E is an electrophil selected from a substituted benzyl of the formula IV, V, VI then x is 2. For example, in case E is an electrophil selected from a substituted benzyl of the formula VII then x is 3. For example, in case E is an electrophil selected from a substituted benzyl of the formula VIII then x is 4. For example, in case E is an electrophil selected from a substituted benzyl of the formula IX then x is 6.

R is C₁-C₁₂ alkyl, C₂-C₁₂ alkenyl, or phenyl. Preferably R is C₁-C₆ alkyl, C₂-C₆ alkenyl (e.g. isopropylene), or phenyl.

More preferably R is methyl, ethyl, or isopropylene. In particular R is methyl or ethyl, and especially ethyl.

In a form the polyoxyzoline is of the formula I, where Z is a benzophenone residue of the formula II, and E is an electrophile residue of the formula III, IV, V, VI, VII, VIII or IX.

In another form the polyoxyzoline is of the formula I, where Z is a benzophenone residue of the formula II, and E is an electrophile residue of the formula III, IV, V, VI, VII, VIII or IX, and R is C₁-C₆ alkyl.

In another form the polyoxyzoline is of the formula I, where Z is a benzophenone residue of the formula II, and E is an electrophile residue of the formula III, IV, V, VI, VII, VIII or IX, R is C₁-C₆ alkyl, and n is from 5 to 50.

In a preferred form the polyoxyzoline is of the formula I, where Z is a benzophenone residue of the formula II, E is a residue of the formula III, and x is 1.

In a more preferred form the polyoxyzoline is of the formula I, where Z is a benzophenone residue of the formula II, E is a residue of the formula III, x is 1, and R is C₁-C₆ alkyl.

In a more preferred form the polyoxyzoline is of the formula I, where Z is a benzophenone residue of the formula II, E is a residue of the formula III, x is 1, R is C₁-C₆ alkyl, and n is from 5 to 50.

In another preferred form the polyoxyzoline is of the formula I, where Z is a benzophenone residue of the formula II, E is a residue of the formula IV, V, VI, VII, VIII or IX, and x is 2, 3, 4, 5 or 6.

In another more preferred form the polyoxyzoline is of the formula I, where Z is a benzophenone residue of the formula II, E is a residue of the formula IV, V, VI, VII, VIII or IX, and x is 2, 3, 4, 5 or 6, and R is C₁-C₆ alkyl.

In another more preferred form the polyoxyzoline is of the formula I, where Z is a benzophenone residue of the formula II, E is a residue of the formula IV, V, VI, VII, VIII or IX, and x is 2, 3, 4, 5 or 6, and R is C₁-C₆ alkyl, and n is from 5 to 50.

The present invention further relates to a method for synthesizing the polyoxazoline of the formula I, comprising the reaction of an aryl ketone which comprises a deprotonated phenolic hydroxy group with an intermediate polyoxazoline of the formula X

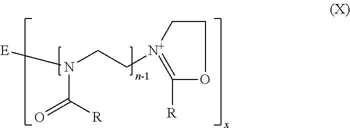

where
E is the electrophile residue,
R is C₁-C₁₂ alkyl,
n is from 2 to 200, and
x is 1, 2, 3, 4, 5 or 6.

The intermediate polyoxazoline of the formula X is usually prepared by cationic ring opening polymerization of a oxazoline monomer of the formula M

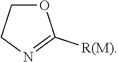

Typical reaction conditions of the cationic ring opening polymerization, such as temperature or solvents, are known to an expert.

The cationic ring opening polymerization is usually initiated by an initiator, which is preferably derived from the residue E, such as by a halide or tosylated or the residue E.

Suitable initiators are alkyl halide, alkenyl halide, alkyl tosylate, alkenyl tosylate, alkyl mesylate, alkenyl mesylate, alkyl triflate, alkenyl triflate, (meth)acryloyl halide, benzyl halide, or a substituted benzyl halide, where the halide may be for example bromide, chloride or iodide or it may be the chloride in combination with a salt that serves to exchange the halide such as potassium iodide.

Preferred initiators are C₁₋₁₈ alkyl halide, C₂₋₁₈ alkenyl halide, C₁₋₁₈ alkyl tosylate, C₂₋₁₈ alkenyl tosylate, C₁₋₁₈ alkyl mesylate, C₂₋₁₈ alkenyl mesylate, C₁₋₁₈ alkyl triflate, C₂₋₁₈ alkenyl triflate, (meth)acryloyl halide, benzyl halide, or a substituted benzyl halide selected from the electrophile residues of the formula III, IV, V, VI, VII, VIII or IX, where the halide may be for example bromide, chloride or iodide. The halides of the formula III, IV, V, VI, VII, VIII or IX have a halide group at the end of the bond with the dashed line. In a preferred form the initiator is a substituted benzyl halide selected from the electrophile residues of the formula IV, V, VI, VII, VIII or IX, where the halide may be for example bromide, chloride or iodide.

The aryl ketone which comprises a deprotonated phenolic hydroxy group is usually obtainable by reacting an aryl ketone which comprises a phenolic hydroxy group with a non-nucleophilic base, such as 1,8-Diazabicyclo[5.4.0]undec-7-ene (DBU), 1,5,7-Triazabicyclo(4.4.0)dec-5-ene (TBD), 7-Methyl-1,5,7-triazabicyclo(4.4.0)dec-5-ene (MTBD), 1,5-Diazabicyclo[4.3.0]non-5-ene (DBN), 3,3,6,9,9-Pentamethyl-2,10-diazabicyclo-(4.4.0)dec-1-ene (PMDBD), 1,1,3,3-Tetra-methylguanidine (TMG), 2,2,6,6-Tetramethylpiperidine (TMP), 2,4,6-Trimethylpyridine (2,4,6-Collidine), 1,2,2,6,6-Pentamethylpiperidine (Pempidine, PMP), Tributlyamine, Triethylamine, 1,4-Diazabicyclo[2.2.2]octan (TED), 2,6-Lutidine (2,6-Dimethylpyridine), N,N-Dicyclohexyl-methylamine, N,N-Diethylaniline, N,N-Dimethylaniline, N,N-Diisopropyl-2-ethylbutylamine, N,N-Diisopropylmethylamine, N,N-Diisopropylethylamine (DIPEA), N,N-Diisopropyl-3-pentylamine, Triisopropylamine, Diisopropylamine, 2,6-Di-tert-butylpyridine, 2,6-Di-tert-butyl-4-methylpyridine, 2,4,6-Tri-tert-butylpyridine, 1,8-Bis(dimethylamino)naphthalene, Tris(trimethylsilyl)amine, Phosphazene bases, Lithium diisopropylamide (LDA), Lithium tetramethylpiperidide (LiTMP), Silicon-based amides, such as lithium, sodium and potassium bis(trimethylsilyl)amide (LiHMDS, NaHMDS and KHMDS, respectively), sodium hydride, potassium hydride, Neopentyllithium, tert-Butyllithium, sodium tert-butoxide, potassium tert-butoxide.

In particular, the non-nucleophilic base is 1,8-Diazabicyclo[5.4.0]undec-7-ene (DBU).

The reaction of the aryl ketone which comprises a phenolic hydroxy group with the strong non-nucleophilic base is usually achieved at temperatures from 0 to 150° C. The reaction time is usually below 1 h, preferably below 0.5 h. The molar ratio between the aryl ketone which comprises a phenolic hydroxy group and the strong non-nucleophilic base is usually in the range from 0.3:1 to 1:3, preferably from 0.8:1 to 1:1.8, and in particular from 1:1 to 1:1.5. The reaction may be made in a non-aqueous solvent, such as acetonitrile.

The aryl ketone which comprises a phenolic hydroxy group may be selected from hydroxybenzophenone (e.g. 2-hydroxybenzophenone, 4-hydroxybenzophenone), hydroxyacetophenone (e.g. 2′-hydroxyacetophenone, 4′-hydroxyacetophenone), hydroxyphenyl glyoxal (e.g. para-hydroxyphenyl glyoxal), hydroxyphenyl glyoxylic acid esters (e.g. (4-hydroxy-phenyl)-glyoxylic acid ethyl ester, (2-hydroxy-phenyl)-glyoxylic acid ethyl ester, (4-hydroxy-phenyl)-glyoxylic acid methyl ester, (2-hydroxy-phenyl)-glyoxylic acid methyl ester), hydroxy anthraquinone (e.g. 1-hydroxy anthraquinone, 2-hydroxy anthraquinone), and 1-hydroxy anthrone.

The reaction of an aryl ketone which comprises a deprotonated phenolic hydroxy group with an intermediate polyoxazoline of the formula X is usually achieved at temperatures from 0 to 150° C.

The reaction time is usually below 1 h. The molar ratio between the deprotonated phenolic hydroxy group and the intermediate polyoxazoline is usually in the range from 0.3:1 to 1:3, preferably from 0.8:1 to 1:1.8, and in particular from 1:1 to 1:1.5. The reaction may be made in a non-aqueous solvent, such as acetonitrile. Examples of non-aqueous solvent include hydrocarbons (e.g. aromatic compounds), esters, ethers, ketones, polar aprotic solvents, and combinations thereof. In one example, the non-aqueous solvent is a polar aprotic solvent, an ester, an ether, a ketone, or an aromatic solvent. Some specific examples of non-aqueous solvent include methyl amyl ketone (MAK), methyl iso-butyl ketone, acetone, methyl ethyl ketone, xylene, Aromatic 100 and 150, acetonitrile, nitromethane.

The present invention further relates to a polymer comprising the polyoxazoline of the formula I, where E comprises an ethylenically unsaturated group in polymerized form.

A suitable electrophile residue E which comprises an ethylenically unsaturated group is the electrophile residue of the formula III.

The ethylenically unsaturated group of the electrophile residue may undergo polymerization, e.g. a radical polymerization under conventional conditions.

In a preferred form of the polymer it comprises the polyoxazoline of the formula I, E is an electrophile residue of the formula III, Z is a benzophenone residue of the formula II, and x is 1.

The present invention further relates to a coated material comprising a coating which contains the polyoxazoline of the formula I or the polymer comprising the polyoxazoline of the formula I, where E comprises an ethylenically unsaturated group in polymerized form.

The coated material is preferably a membrane.

The present invention further relates to a use of the polyoxazoline of the formula I or the polymer comprising the polyoxazoline of the formula I, where E comprises an ethylenically unsaturated group in polymerized form as antifouling coating.

### EXAMPLES

Coating: The coatings were produced by means of a film applicator (ERICHSEN GmbH & Co. KG, COATMASTER 509 MC) and a spin coater (ATM Vision AG, primus STT15).
UV irradiation: UV-treatments were performed using an UV-chamber from Dr. Hönle AG for UV-technology (UVACUBE 100, with F-radiator and H1 filter).
Plasma surface treatment: The plasma surface treatment was carried out using a plasma-chamber from Diener electronic GmbH & Co. KG (Plasma-Surface-Technology, Pico).
Ellipsometric measurements: The gel fractions were analyzed by ellipsometric measurements (Ellipsometer: alfa-SE™; J. A. Woollam Co., Inc.; Ellipsometry Solutions). The film thicknesses were determined by using a Cauchy model for the refractive index of the polymer layers with A=1.53; B=6.32·10⁻³; C=9.61·10⁻⁵.
SEC measurements: Polymer molecular weights and polymer molecular weight distributions were determined using size exclusion chromatography. A series of polyester copolymer columns from Polymer Standards Service GmbH, Germany (PSS) were used at 35° C.: GRAM precolumn (Gold) inner diameter 8 mm, length 5 cm; GRAM 30A (Gold) inner diameter 8 mm, length 30 cm 100-10000 g/mol; GRAM 1000A (Gold) inner diameter 8 mm, length 30 cm 1000-1000000 g/mol; GRAM 1000A (Gold) inner diameter 8 mm, length 30 cm 1000-1000000 g/mol. The eluent was DMAC+0.05% TFAc+0.5% LiBr at a flow rate of 1 mL/min. Samples were prefiltered through a Sartorius Minisart RC 25 (0.2 μm) filter and 100 μL injected at a concentration of 4 mg/mL. Calibration was done using poly(methyl methacrylate) standards of PSS in the molecular weight range M=102-M=853.000.
MALDI mass spectrometry measurements: Positive ion MALDI-MS spectra were acquired using methanol as solvent and NaTFA/DHB as Matrix.

### Example 1: Synthesis of BP-Macromonomers: VBC-PMOXA(10,20,40)-BP

Potassium iodide (18.54 g; 110.6 mmol; molar ratio (relating to VBC):1.2), Acetonitrile (240 g), 2-Methyloxazoline (80 g; 921.3 mmol; molar ratio (relating to VBC):10) and 4-Vinylbenzyl chloride (VBC, 15.62 g; 92.1 mmol, molar ratio:1) were mixed in the named order and heated up to 80° C. in presence of Nitrogen. The mixture was stirred for 4 h at 80° C.

In a separate flask 4-Hydroxybenzophenone (22.36 g; 110.6 mmol; molar ratio (relating to VBC):1.2) was dissolved in Acetonitrile (80 g) before 1,8-Diazabicyclo[5.4.0]undec-7-ene (17 g; 110.6 mmol; molar ratio (relating to VBC):1.2) was added. The resulting solution was put fast into the main reaction mixture after the named time of polymerization (T_{addition}=80° C.). From that moment all working steps were done with exclusion of light. The yield was quantitative. After 30 min, the mixture was cooled to room temperature. After filtration (folded filter), solvent was removed by drying in vacuum at 60° C. In table 4 the quantities of the input materials for the three VBC-PMOXA(10,20,40)-BP are summarized. The molar ratios were the same for all macromonomers with exception of the molar ratio of MOXA (molar ratio (relating to VBC):10; 20; 40). After drying yellow powders were obtained in quantitative yield.

Purification: The macromonomer X1 (VBC-PMOXA(10)-BP, 2 g) was mixed with 50 g of water to obtain a yellow suspension. The suspension was extracted three times with 50 g ethyl acetate: Following 10 min of stirring, the aqueous phase was separated using a separating funnel. The organic phase was disposed. After extraction the transparent aqueous phase was additionally purified by three times dialyzing against 5 L VE-water for 12 hours using dialysis membrane 6 (Spectra/Por, MWCO=1 kDa). The resulting aqueous phase was filtrated using syringe filters and dried in vacuum at 60° C. White powder was obtained All working steps were done with exclusion of light.

¹H NMR (VBC-PMOXA(10)-BP in CD₃CN): 1.7 ppm (m, DBU), 2 ppm (brt, 30H, —CH₃), 2.7 ppm (d, DBU), 3.3 ppm (t, DBU), 3.4 ppm (brs, 40H, CH₂—N), 3.5 ppm (t, DBU), 4.22 ppm (s, 2H, CH₂—O-AR), 4.55 ppm (s, 2H, AR-CH₂—N), 5.25 ppm, 5.8 ppm, 6.75 ppm (t, each 1H, vinyl protons), 6.85 ppm (d, 2H, excess HBP), 7.1 (d, 2H, converted HBP), 7.2-7.8 ppm (m, 11H, aromatic Protons of VBC and HBP).

¹H NMR (VBC-PMOXA(20)-BP in CD₃CN): 1.7 ppm (m, DBU), 2 ppm (brt, 60H, —CH₃), 2.7 ppm (d, DBU), 3.3 ppm (t, DBU), 3.4 ppm (brs, 80H, CH₂—N), 3.5 ppm (t, DBU), 4.22 ppm (s, 2H, CH₂—O-AR), 4.55 ppm (s, 2H, AR-CH₂—N), 5.25 ppm, 5.8 ppm, 6.75 ppm (t, each 1H, vinyl protons), 6.85 ppm (d, 2H, excess HBP), 7.1 (d, 2H, converted HBP), 7.2-7.8 ppm (m, 11H, aromatic Protons of VBC and HBP).

¹H NMR (VBC-PMOXA(40)-BP in CD₃CN): 1.7 ppm (m, DBU), 2 ppm (brt, 120H, —CH₃), 2.7 ppm (d, DBU), 3.3 ppm (t, DBU), 3.4 ppm (brs, 160H, CH₂—N), 3.5 ppm (t, DBU), 4.22 ppm (s, 2H, CH₂—O-AR), 4.55 ppm (s, 2H, AR-CH₂—N), 5.25 ppm, 5.8 ppm, 6.75 ppm (t, each 1H, vinyl protons), 6.85 ppm (d, 2H, excess HBP), 7.1 (d, 2H, converted HBP), 7.2-7.8 ppm (m, 11H, aromatic Protons of VBC and HBP).

IR (purified VBC-PMOXA(10)-BP): 3469, 2932, 1743, 1645, 1421, 1365, 1254, 1033, 855, 793 cm⁻¹.

Elemental analysis of purified VBC-PMOXA(10)-BP: Calculated for C₆₂H₈₈O₁₂N₁₀: C=63.9%, H=7.6%, O=16.5%, N=12.0%; found: C=57.6%, H=8.1%, O=22.5%, N=12.1%. MALDI-MS (VBC-PMOXA(10)-BP=C₆₂H₈₈O₁₂N₁₀): Main peak found=1187.642. Theoretical value [M+Na⁺]=1187.

MALDI-MS (VBC-PMOXA(20)-BP=C₁₀₂H₁₅₈O₂₂N₂₀): Main peak found=2038.177. Theoretical value [M+Na⁺]=2037.

TABLE 1
Synthesis of BP-macromonomers X1 to X3

| | Macromonomer | VBC/g | MOXA/g | KI/g | AcN/g | HBP/g | AcN/g | DBU/g |
|---|---|---|---|---|---|---|---|---|
| X1 | VBC- | 15.62 | 80 | 18.54 | 240 | 22.36 | 80 | 17.00 |
| | PMOXA(10)-BP¹ | | | | | | | |
| X2 | VBC- | 7.81 | 80 | 9.27 | 240 | 11.18 | 40 | 8.50 |
| | PMOXA(20)-BP² | | | | | | | |
| X3 | VBC- | 3.12 | 80 | 3.71 | 240 | 4.47 | 16 | 3.40 |
| | PMOXA(40)-BP³ | | | | | | | |

¹4 h polymerization.
²6 h polymerization.
³15 h polymerization.

### Examples 2: Synthesis of Star-Like Polymers: TrisBMB-PMOXA(3×10,20,50)-BP

1,3,5-Tris(bromomethyl)benzene (TrisBMB, 11.29 g; 90.7 mmol; molar ratio (relating to initiator groups=amount of bromomethyl groups):0.333), Acetonitrile (240 g) and 2-Methyloxazoline (80 g; 921.3 mmol; molar ratio (relating to initiator groups):10) were mixed in the named order and heated up to 80° C. in presence of Nitrogen. The mixture was stirred for 4 h at 80° C. In a separate flask 4-Hydroxybenzophenone (22.36 g; 110.6 mmol; molar ratio (relating to initiator groups):1.2) was solved in Acetonitrile (80 g) before 1,8-Diazabicyclo[5.4.0]undec-7-ene (17 g; 110.6 mmol; molar ratio (relating to initiator groups):1.2) was added. The resulting solution was put fast into the main reaction mixture after the named time of polymerization (T_{addition}=80° C.). From that moment all working steps were done with exclusion of light. After 30 min, the mixture was cooled to room temperature. After filtration (folded filter), solvent was removed by drying in vacuum at 60° C. In table 5 the quantities of the input materials for the three TrisBMB-PMOXA(3×10,20,50)-BP are summarized. The molar ratios were the same for all star-like polymers with exception of the molar ratio of MOXA (molar ratio (relating to initiator groups):10; 20; 50). After drying yellow powders were obtained in quantitative yield. Purification: 1-2 g of X4-X6 were dissolved in 50 mL VE-water and filtrated through a syringe filter. X4 and X5 were transferred into a dialysis membrane 3 (Spectra/Por, MWCO=3.5 kDa), X6 into a dialysis membrane 4 (Spectra/Por, MWCO=12-14 kDa) and dialyzed against 5 L fresh VE-water 6 times for 12 hours.

¹H NMR (TrisBMB-PMOXA(3×10)-BP in CD₃CN): 1.7 ppm (m, DBU), 2 ppm (brt, 90H, —CH₃), 2.7 ppm (d, DBU), 3.3 ppm (t, DBU), 3.4 ppm (brs, 120H, CH₂—N), 3.5 ppm (t, DBU), 4.22 (s, 6H, CH₂—O-AR), 4.55 ppm (s, 3×2 H, AR-CH₂—N), 6.5 ppm (d, 3×2 H, excess HBP), 7.05 (d, 3×2 H, converted HBP), 7.4-7.8 ppm (m, 1×3 H+3×7 H, aromatic Protons of TrisBMB and HBP).

¹H NMR (TrisBMB-PMOXA(3×20)-BP in CD₃CN): 1.7 ppm (m, DBU), 2 ppm (brt, 180H, —CH₃), 2.7 ppm (d, DBU), 3.3 ppm (t, DBU), 3.4 ppm (brs, 240H, CH₂—N), 3.5 ppm (t, DBU), 4.22 (s, 6H, CH₂—O-AR), 4.55 ppm (s, 3×2 H, AR-CH₂—N), 6.7 ppm (d, 3×2 H, excess HBP), 7.05 (d, 3×2 H, converted HBP), 7.4-7.8 ppm (m, 1×3 H+3×7 H, aromatic Protons of TrisBMB and HBP).

¹H NMR (TrisBMB-PMOXA(3×50)-BP in CD₃CN): 1.7 ppm (m, DBU), 2 ppm (brt, 450H, —CH₃), 2.7 ppm (d, DBU), 3.3 ppm (t, DBU), 3.4 ppm (brs, 600H, CH₂—N), 3.5 ppm (t, DBU), 4.22 (s, 6H, CH₂—O-AR), 4.55 ppm (s, 3×2 H, AR-CH₂—N), 6.9 ppm (d, 3×2 H, excess HBP), 7.05 (d, 3×2 H, converted HBP), 7.4-7.8 ppm (m, 1×3 H+3×7 H, aromatic Protons of TrisBMB and HBP).

SEC data (dialysed Tris-BMB-PMOXA(3×10)-BP): M_{w}=4,640 g·mol⁻¹, M_{w}=5,660 g·mol⁻¹, PDI=1.2. SEC data (dialysed Tris-BMB-PMOXA(3×20)-BP): M_{w}=7,210 g·mol⁻¹, M_{w}=9,420 g·mol⁻¹, PDI=1.3.

TABLE 2
Synthesis of star-like polymers.

| | star-like polymer | TrisBMB/g | MOXA/g | AcN/g | HBP/g | AcN/g | DBU/g |
|---|---|---|---|---|---|---|---|
| X4 | TrisBMB- | 15.62 | 80 | 240 | 22.36 | 80 | 17.00 |
| | PMOXA(3 × 10)-BP¹ | | | | | | |
| X5 | TrisBMB- | 7.81 | 80 | 240 | 11.18 | 40 | 8.50 |
| | PMOXA(3 × 20)-BP² | | | | | | |
| X6 | TrisBMB- | 3.12 | 80 | 240 | 4.47 | 16 | 3.40 |
| | PMOXA(3 × 50)-BP³ | | | | | | |

¹4 h polymerization.
²6 h polymerization.
³15 h polymerization.

### Examples 3: Synthesis of Di- and Tetra-Functional Polymers

Reaction was carried out according to examples X3-X6 using the initiators α,α′-Dichlor-p-xylene (DCPX, di-functional; molar ratio (relating to initiator groups):0.5), α,α′-Dibrom-p-xylene (DBPX, di-functional; molar ratio (relating to initiator groups):0.5), 1,2,4,5-Tetrakis(brommethyl)benzene (TetrakisBMB, tetra-functional; molar ratio (relating to initiator groups):0.25) with a molar ratio of MOXA relating to initiator groups:10; molar ratio of DBU relating to initiator groups:1.2 and a molar ratio of 4-HBP relating to initiator groups:1.2.

X7: ¹H NMR (DCPX-PMOXA(2×10)-BP (GM0960-0063) in Acetonitrile): 1.7 (m, DBU), 2 ppm (brt, 60H, —CH₃), 2.7 ppm (d, DBU), 3.3 ppm (t, DBU), 3.4 ppm (brs, 80H, CH₂—N), 3.5 ppm (t, DBU), 4.22 ppm (s, 4H, CH₂—O-AR), 4.55 ppm (s, 2×2 H, AR-CH₂—N), 6.85 ppm (d, 2×2 H, excess HBP), 7.05 ppm (d, 2×2 H, converted HBP), 7.15-7.8 ppm (m, 1×4 H+2×7 H, aromatic Protons of DCPX and HBP). Quantitative yield.

X8: ¹H NMR (DBPX-PMOXA(2×10)-BP (GM0960-0064) in Acetonitrile): 1.7 (m, DBU), 2 ppm (brt, 60H, —CH₃), 2.7 ppm (d, DBU), 3.3 ppm (t, DBU), 3.4 ppm (brs, 80H, CH₂—N), 3.5 ppm (t, DBU), 4.22 ppm (s, 4H, CH₂—O-AR), 4.55 ppm (s, 2×2 H, AR-CH₂—N), 6.85 ppm (d, 2×2 H, excess HBP), 7.05 ppm (d, 2×2 H, converted HBP), 7.15-7.8 ppm (m, 1×4 H+2×7 H, aromatic Protons of DBPX and HBP). Quantitative yield.

X9: ¹H NMR (TetrakisBMB-PMOXA(4×10)-BP (GM0960-0075) in Acetonitrile): 1.7 (m, DBU), 2 ppm (brt, 120H, —CH₃), 2.7 ppm (d, DBU), 3.3 ppm (t, DBU), 3.4 ppm (brs, 160H, CH₂—N), 3.5 ppm (t, DBU), 4.22 ppm (s, 4H, CH₂—O-AR), 4.55 ppm (s, 2×2 H, AR-CH₂—N), 6.55 ppm (d, 2×2 H, excess HBP), 7.05 ppm (d, 2×2 H, converted HBP), 7.4-7.8 ppm (m, 1×2 H+4×7 H, aromatic Protons of TetrakisBMB and HBP). Quantitative yield.

### Examples 4: Copolymerization of VBC-PMOXA(10)-OH and VBC-PMOXA(10)-BP

### Examples 4a: Synthesis of Hydroxy-Terminal Polyoxazoline Macromonomers VBC-PMOXA(10,20,40)-OH (Compounds Y1-Y3)

Potassium iodide (27.81 g; 165.8 mmol; molar ratio (relating to VBC):1.2), Acetonitrile (360 g), 2-Methyloxazoline (120 g; 1382 mmol; molar ratio (relating to VBC):10) and 4-Vinylbenzyl chloride (VBC, 23.43 g; 138.2 mmol, molar ratio:1) were mixed in the named order and heated up to 80° C. under stirring and in presence of Nitrogen. After 4 h the mixture was cooled down to 75° C. and Sodium hydroxide solution (82.91 g, 8 wt.-%; 165.8 mmol, molar ratio (relating to VBC):1.2) was added fast. 30 min later, the mixture was further cooled to room temperature. After filtration (folded filter), solvent was removed by drying in vacuum at 60° C. In table 3 the quantities of input materials for the three VBC-PMOXA(10,20,40)-OH are summarized. The molar ratios were the same for all macromonomers with exception of the molar ratio of MOXA (molar ratio (relating to VBC):10; 20; 40). After drying a white to yellow powder was obtained depending on the molar ratio of MOXA (yellow:molar ratio (MOXA):10; white:molar ratio (MOXA):40). The yield was quantitative.

Purification: The macromonomer Y1 (VBC-PMOXA(10)-OH, 2 g) was mixed with 50 g of water to obtain a yellow suspension. The suspension was extracted three times with 50 g ethyl acetate: Following 10 min of stirring, the aqueous phase was separated using a separating funnel. The organic phase was disposed. After extraction the transparent aqueous phase was additionally purified by three times dialyzing against 5 L VE-water for 12 hours using dialysis membrane 6 (Spectra/Por, MWCO=1 kDa). The resulting aqueous phase was filtrated using syringe filters and dried in vacuum at 60° C. White powder was obtained. All working steps were done with exclusion of light.

¹H NMR (VBC-PMOXA(10)-OH in CD₃CN): 2 ppm (brt, 30H, —CH₃), 3.4 ppm (brs, 40H, CH₂—N), 4.55 ppm (s, 2H, AR-CH₂—N), 5.25 ppm, 5.8 ppm, 6.75 ppm (t, each 1H, vinyl protons), 7.2-7.5 ppm (m, 4H, C₆H₄).

¹H NMR (VBC-PMOXA(20)-OH in CD₃CN): 2 ppm (brt, 60H, —CH₃), 3.4 ppm (brs, 80H, CH₂—N), 4.55 ppm (s, 2H, AR-CH₂—N), 5.25 ppm, 5.8 ppm, 6.75 ppm (t, each 1H, vinyl protons), 7.2-7.5 ppm (m, 4H, C₆H₄).

¹H NMR (VBC-PMOXA(40)-OH in CD₃CN): 2 ppm (brt, 120H, —CH₃), 3.4 ppm (brs, 160H, CH₂—N), 4.55 ppm (s, 2H, AR-CH₂—N), 5.25 ppm, 5.8 ppm, 6.75 ppm (t, each 1H, vinyl protons), 7.2-7.5 ppm (m, 4H, C₆H₄).

IR (purified VBC-PMOXA(10)-OH): 3441, 2937, 1640, 1478, 1421, 1364, 1255, 1014, 829 cm⁻¹. SEC data (VBC-PMOXA(10)-OH): Mn=1,320 g·mol⁻¹, M_{w}=1,490 g·mol⁻¹, PDI=1.1. GPC data (VBC-PMOXA(20)-OH): Mn=2,270 g·mol⁻¹, M_{w}=2,640 g·mol⁻¹, PDI=1.2. GPC data (VBC-PMOXA(40)-OH): Mn=4,030 g·mol⁻¹, M_{w}=5,160 g·mol⁻¹, PDI=1.3.

Elemental analysis of purified VBC-PMOXA(10)-OH: Calculated for C₄₉H₈₀O₁₁N₁₀: C=59.8%, H=8.1%, O=17.9%, N=14.2%; found: C=56.8%, H=8.4%, O=21.0%, N=13.5%.

TABLE 3
Synthesis of OH-macromonomers Y1-Y3

| | Macromonomer | VBC/g | MOXA/g | NaOH/g | KI/g | AcN/g |
|---|---|---|---|---|---|---|
| Y1 | VBC- | 23.43 | 120 | 82.91 | 27.81 | 360 |
| | PMOXA(10)-OH¹ | | | | | |
| Y2 | VBC- | 11.72 | 120 | 41.46 | 13.90 | 360 |
| | PMOXA(20)-OH² | | | | | |
| Y3 | VBC- | 3.12 | 80 | 11.06 | 3.71 | 240 |
| | PMOXA(40)-OH³ | | | | | |

¹4 h polymerization.
²6 h polymerization.
³15 h polymerization.

### Example 4b: Copolymerization of VBC-PMOXA(10)-OH and VBC-PMOXA(10)-BP

Different amounts of VBC-PMOXA(10)-OH (Y1) and VBC-PMOXA(10)-BP (X1) (in total 7.5 g), 2,2′-Azobis(2-methylpropionamidine)dihydrochloride (Wako V-50; 0.5 wt.-%; 37.5 mg) and VE-water (142.5 g) were heated to 75° C. for 5 h. All working steps were done with exclusion of light. The dried macromonomers were used without purification. The resulting reaction medium was filtrated using a folded filter and dried in vacuum at 60° C. White to yellow powders were obtained depending on the composition of the macromonomers (Yield: 90% (1/1) to 96% (64/1)).

Purification: 1-2 g of X10-X16 were dissolved in 50 mL VE-water each and filtrated through a syringe filter. Then the products were transferred into a dialysis membrane 1 (Spectra/Por, MWCO=6-8 kDa) and dialyzed against 5 L fresh VE-water 4 times for 12 hours.

TABLE 4
Copolymerization of OH- and BP-PMOXA(10)
macromonomers in different ratios.

| | Ratio OH/BP | m(VBC-PMOXA(10)-OH)/g | m(VBC-PMOXA(10)-BP)/g |
|---|---|---|---|
| X10 | 1/1 | 3.75 | 3.75 |
| X11 | 2/1 | 5.00 | 2.50 |
| X12 | 4/1 | 6.00 | 1.50 |
| X13 | 8/1 | 6.67 | 0.83 |
| X14 | 16/1 | 7.06 | 0.44 |
| X15 | 32/1 | 7.27 | 0.23 |
| X16 | 64/1 | 7.38 | 0.12 |

### Examples 5: Copolymerization of VBC-PMOXA(10,20,40)-OH and VBC-PMOXA(10,20,40)-BP

Different amounts of VBC-PMOXA(10,20,40)-OH (Y1,Y2,Y3) and VBC-PMOXA(10,20,40)-BP (X1,X2,X3) (in total 7.5 g), 2,2′-Azobis(2-methylpropionamidine)dihydrochloride (Wako V-50; 0.5 wt.-%; 37.5 mg) and VE-water (142.5 g) were stirred at 75° C. for 5 h. All working steps were done with exclusion of light. The molar ratio of OH/BP was fixed to 4/1 (calculated by molar masses of 1000, 2000 and 4000 g·mol⁻¹ for VBC-PMOXA(10,20,40)-OH/BP). The dried macromonomers were used without purification. The resulting reaction medium was filtrated and dried in vacuum at 60° C. White powders were obtained (Y≥95%).

Purification: 1-2 g of X17-X25 were dissolved in 50 mL VE-water each and filtrated through a syringe filter. Then the products were transferred into a dialysis membrane 4 (Spectra/Por, MWCO=12-14 kDa) and dialyzed against 5 L fresh VE-water 4 times for 12 hours.

TABLE 5
Copolymerization of different OH- and BP-macromonomers in 4/1 ratio.

| | OH-MM + BP-MM | m(VBC-PMOXA( . . . )-OH)/g | m(VBC-PMOXA( . . . )-BP)/g |
|---|---|---|---|
| X17 | 10 + 10 (Y1 + X1) | 6.00 | 1.50 |
| X18 | 10 + 20 (Y1 + X2) | 5.00 | 2.50 |
| X19 | 10 + 40 (Y1 + X3) | 3.75 | 3.75 |
| X20 | 20 + 10 (Y2 + X1) | 6.67 | 0.83 |
| X21 | 20 + 20 (Y2 + X2) | 6.00 | 1.50 |
| X22 | 20 + 40 (Y2 + X3) | 5.00 | 2.50 |
| X23 | 40 + 10 (Y3 + X1) | 7.06 | 0.44 |
| X24 | 40 + 20 (Y3 + X2) | 6.67 | 0.83 |
| X25 | 40 + 40 (Y3 + X3) | 6.00 | 1.50 |

### Example 6: Coating of Copolymers X10-X16 and of Star-Like Polymers X4 and X5 onto Pretreated Silicon Wafers

### Example 6a: Pretreatment of the Si-Wafer (HMDS)

The Si-wafer was cut in small square pieces (about 2×2 cm) by using lint-free clothes and a diamond cutter. After rinsing them with Methanol for 5 s, the pieces were dried by an air stream (compressed air line of the laboratory). They were treated with Oxygen plasma for 60 s and then hydrophobized by exposing them to a vapor of Hexamethyldisilazane for 20 h at room temperature[^{53;54}] (1 mL HMDS in an desiccator with an diameter of about 30 cm). After that the pieces were treated a second time with Oxygen plasma but only for 6 s. The average film thickness (SiO₂, HMDS, plasma-treatment) was 2.3 nm (Ellipsometry database of GMC/O: Substrate: SI_JAW; film after treatment: SiO₂).

### Example 6b: Coating of Copolymers X10-X16 and of Star-Like Polymers X4 and X5 onto Pretreated Silicon Wafers

The pieces of Si-wafer pretreated according to example 26 were placed on the spin coater and spun at 2000 rpm for 40 s. As soon as the maximum rotation speed was reached, 1 mL of the relevant polymer solution (each 2.0 wt. % in methanol) was applied onto the spinning wafer piece. After drying in air, the thin polymer film was cured by UV-irradiation for 60 s. Thicknesses of polymer coatings before and after extraction with methanol were analyzed by ellipsometry. The gel fraction of the coating was determined as the ratio of polymer coating thickness after extraction and before extraction multiplied by 100%. All copolymers X10-X16 were synthesized under the same conditions as described for Y4. SEC analysis of Y4 relates to an overall degree of polymerization of the macromonomers of 28. This allows to calculate the average number of benzophenone group per copolymer macromolecule X10-X16. If the number of benzophenone groups per macromolecule, i.e. the cross-linking points, is equal to or greater than approximately 3, the gel fraction was found to be equal to or greater than 95%. This is very well within the expectation of an effective cross-linking for macromolecules comprising of at least 2-3 cross-linking units. The data is summarized in table 8 together with results for the coating and cross-linking of X4 and X5.

TABLE 6
Comparison of gel fractions of coatings of X10-X16
after extraction with methanol with theoretical calculated
number of benzophenone per macromolecule.

| | | VBC-PMOXA(10)-BP/ | number of BP/ | Gel |
|---|---|---|---|---|
| | Polymer | VBC-PMOXA(10)-OH | macromolecule | fraction/% |
| 27 | X10 | 1/1 | 22.8 | 96.4 |
| 28 | X11 | 2/1 | 11.4 | 97.6 |
| 29 | X12 | 4/1 | 5.7 | 96.9 |
| 30 | X13 | 8/1 | 2.9 | 95.0 |
| 31 | X14 | 16/1 | 1.4 | 87.5 |
| 32 | X15 | 32/1 | 0.7 | 71.8 |
| 33 | X16 | 64/1 | 0.4 | 14.4 |
| 34 | X4 | N/A | <=3 | 78 |
| 35 | X5 | N/A | <=3 | 79 |

### Example 7: Bacteria Antiadhesiveness Test

Polymer films were applied to PES (polyether sulfone) foil from polymer solutions X10 and X5 (1 wt. % in MeOH; 15 μm draw down bar slit width; 15 mm/s), dried in air at room temperature and subsequently irradiated with UV-light for 300 s.

Bacteria culture: Staphylococcus aureus Lu14886 from glycerol stock was streaked onto an agar plate and incubated for 3 days at 37° C. From this plate, bacteria were transferred using an inoculation loop in 50 mL TSBY (tryptic soy broth supplemented with yeast)-medium and incubated overnight at 37° C. and 190 rpm (OD=10.70). This culture was used to prepare the test culture by inoculation of a 5% TSBY medium to an optical density (OD) of 1.0. The test culture was supplemented with Syto®9 (ThermoFisher Scientific) as recommended by the manufacturer to stain bacteria cells green fluorescent.

Coated samples and the uncoated PES foil were placed in a custom made 12-well holder made from stainless steel with transparent bottom such that only the top surface was exposed and sealed. 1 mL of the test culture was pipetted into each well and incubated for 2 h at 37° C. (no shaking, covered to minimize light exposure and bleaching of the fluorescent dye). Then non-adherent cells were removed by gentle washing through multiple partial solution exchanges (10times 900 μL culture was removed and replaced with 900 μL sterile saline).

Afterwards, green fluorescent images were taken in situ without drying the samples using an inverted microscope and the number of bacteria were counted. Average values and standard deviations of at least 3 images from 3 samples were taken. The results are summarized in Table 7.

TABLE 7

| Example | Surface | Number of adherent bacteria |
|---|---|---|
| 36 | Blank PES film | 1240 ± 920 |
| 37 | X5-coated PES film | 105 ± 70 |
| 38 | X10-coated PES film | 50 ± 50 |

### Example 8: Membrane Coating and Permeation

The membrane (flat sheet Nadir® UP150 a PES polyethersulfone membrane, PE/PP MWCO: 150 kDa; 5 min immersion in ultrapure water, drying with lint-free clothes) was coated as long as the membrane was still slightly moist. Polymer films were applied to membranes from polymer solutions X10-X14 and X4 and X5 (1-1.2 wt. % in MeOH; 15 μm draw down bar slit width; 15 mm/s), dried in air at room temperature and subsequently irradiated with UV-light for 180 s. Pure water permeation (PWP) tests were carried out in a custom made dead-end cell at room temperature using approximately 10 cm diameter die-cut coated or con-coated membrane sheets. The cell had a feed volume of approximately 300 mL and deionized water was used as the feed. The weight of the permeate was recorded as a function of time to determine the PWP. The transmembrane pressure was fixed to 1 bar, then increased to 4 bar and reset to 1 bar.

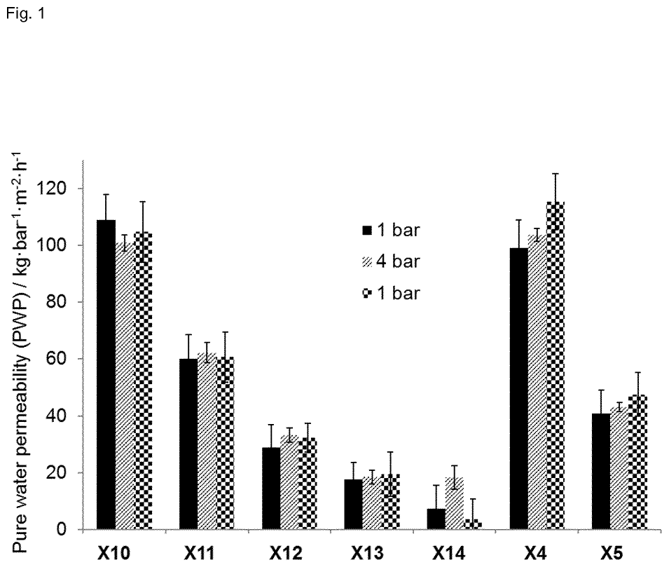

FIG. 1 shows the pure water permeability of Nadir® UP150 membranes coated with Polymers X10, X11, X12, X13, X14, X4, X5. Thus, it was demonstrated that a high water permeability can still be reached with a effective antifouling coated membrane.

1: A polyoxazoline of the following formula I: 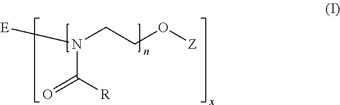
wherein
E is an electrophile residue,
R is C₁-C₁₂ alkyl, C₂-C₁₂ alkenyl, or phenyl,
Z is an aryl ketone residue,
n is from 2 to 200, and
x is 1, 2, 3, 4, 5 or 6.

2: The polyoxazoline according to claim 1, wherein Z is an aryl ketone residue derived from at least one selected from the group consisting of benzophenone, acetophenone, phenyl glyoxyl, phenyl glyoxylic acid esters, anthraquinone, anthrone, and anthrone derivatives.

3: The polyoxazoline according to claim 1, wherein Z is a benzophenone residue of the formula II:

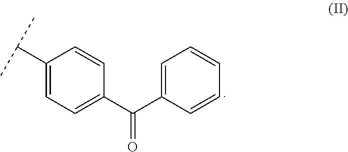

4: The poyoxazoline according to claim 1, wherein E is an electrophile selected from C₁₋₁₈ alkyl, C₂₋₁₈ alkenyl, (meth)acryloyl, benzyl, or a substituted benzyl selected from the electrophile residues of the formula III, IV, V, VI, VII, VIII or IX

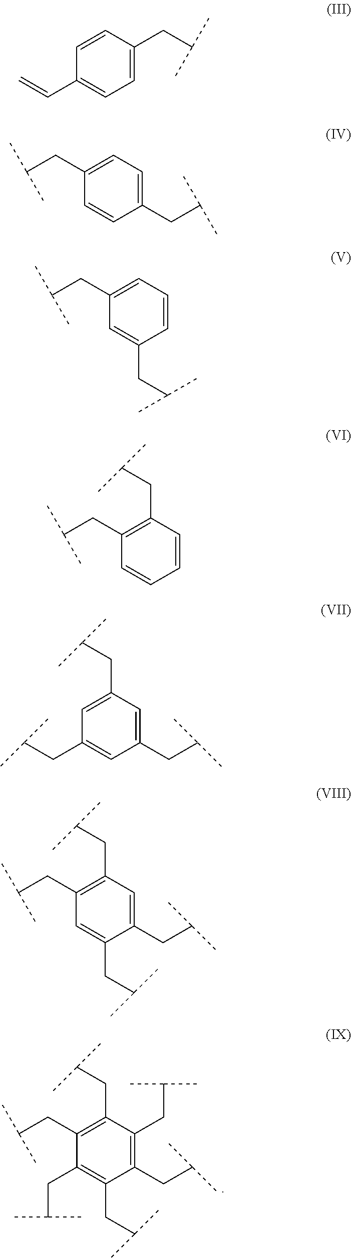

5: The polyoxazoline according to claim 1, wherein Z is the benzophenone residue of the formula II: 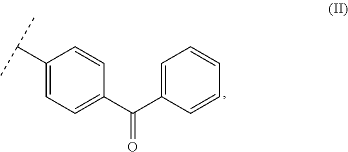
E is the electrophile residue of the formula III: 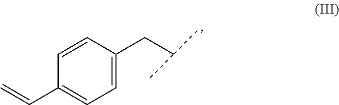
and
x is 1.

6: The polyoxazoline according to claim 1, wherein
Z is the benzophenone residue of the formula II: 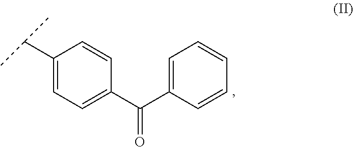
E is the electrophile residue of the formula IV, V, VI, VII, VIII or IX: 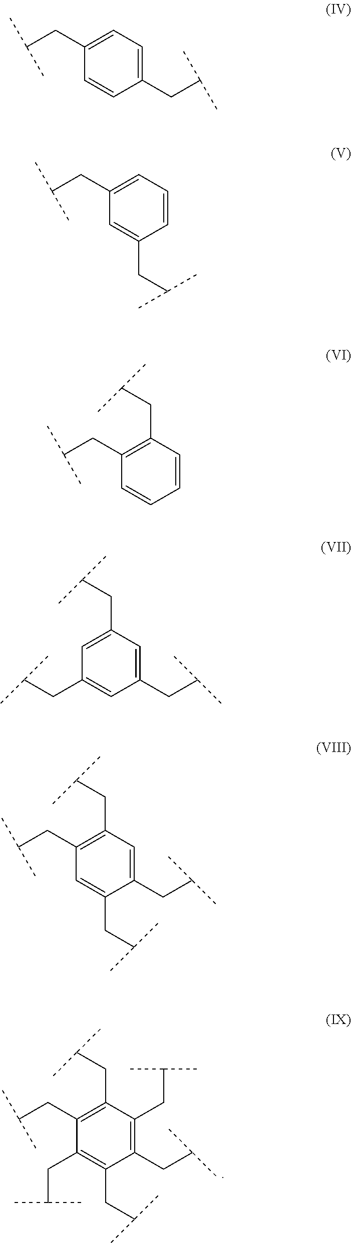
and
x is 2, 3, 4, 5 or 6.

7: The polyoxazoline according to claim 1, wherein R is C₁-C₆ alkyl.

8: A method for synthesizing the polyoxazoline of the formula I according to claim 1, the method comprising reacting an aryl ketone which comprises a deprotonated phenolic hydroxy group with an intermediate polyoxazoline of the formula X 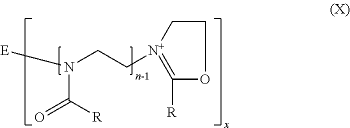
wherein
E is an electrophile residue,
R is C₁-C₁₂ alkyl,
Z is an aryl ketone residue,
n is from 2 to 200, and
x is 1, 2, 3, 4, 5 or 6.

9: The method according to claim 8, wherein the aryl ketone which comprises a deprotonated phenolic hydroxy group is obtained by reacting an aryl ketone which comprises a phenolic hydroxy group with 1,8-diazabicyclo[5.4.0]undec-7-ene.

10: The method according to claim 8, wherein the aryl ketone which comprises a phenolic hydroxy group is selected from the group consisting of hydroxybenzophenone, hydroxyacetophenone, hydroxyphenyl glyoxal, hydroxy anthraquinone, and 1-hydroxy anthrone.

11: A polymer comprising the polyoxazoline of the formula I according to claim 1, wherein E comprises an ethylenically unsaturated group in polymerized form.

12: The polymer according to claim 11, wherein
E is the electrophile residue of the formula III: 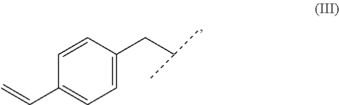
Z is the benzophenone residue of the formula II: 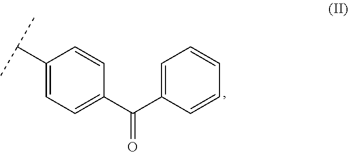
and
x is 1.

13: A coated material comprising a coating which comprises the polyoxazoline of the formula I according to claim 1.

14: The coated material according to claim 13, wherein the material is a membrane.

15: An antifouling coating, comprising the polyoxazoline of the formula I according to claim 1.
